(19) United States
(12) Patent Application Publication
(10) Pub. No.: US 2012/0007370 A1
(43) Pub. Date: Jan. 12, 2012

(54) Fuel Cell System Comprising at Least One Fuel Cell

(75) Inventors: Gerhard Konrad, Ulm (DE); Felix Sterk, Schlier (DE)

(73) Assignee: DAIMLER AG, Stuttgart (DE)

(21) Appl. No.: 13/202,203

(22) PCT Filed: Jan. 27, 2010
(86) PCT No.: PCT/EP2010/000472

§ 371 Date: Sep. 29, 2011

(30) Foreign Application Priority Data
Feb. 19, 2009 (DE) 10 2009 009 675.2

(51) Int. Cl. H01M 8/06; H02K 7/18; F01K 27/00

(52) U.S. Cl. 290/1 R; 429/415; 429/414; 60/685

(57) ABSTRACT

A fuel cell system includes a fuel cell with a cathode region and an anode region. The fuel cell system also includes at least one device, which is flown through by an intake air flow flowing to the cathode region and by a used air stream discharged from the cathode region. It also includes catalytic material for the thermal conversion of fuel-containing gas. A first unit with catalytic material is arranged in the flow direction of the intake air flow upstream the at least one device. An exhaust gas from the anode region can be fed to this first unit as a fuel-containing gas. A second unit with catalytic material is arranged in the flow direction of the used air flow downstream of the at least one device.

### BACKGROUND AND SUMMARY OF THE INVENTION

The invention relates to a fuel cell system comprising at least one fuel cell.

German patent document DE 101 15 336 A1 discloses a fuel cell system with an anode cycle. Thus, the document concerns the handling of hydrogen-containing exhaust gas, which has to be emitted from the region of the anode cycle with a cycle guidance of the anode gases from time to time. To achieve this it is suggested to introduce the hydrogen-containing gas into the region of the intake air to the cathode region of the fuel cell, so that this reacts together with the oxygen of the intake air at a catalyst, particularly at the catalyst that is present in any case in the region of the cathode.

This dosing of hydrogen-containing exhaust gas from the anode region of the fuel cell has a negative effect on the conditioning of the intake air to the cathode region of the fuel cell with regard to the temperature developed during the reaction. If the reaction is also permitted in the region of the catalyst at the cells themselves, a quicker ageing of the fuel cells is effected. The construction thus has the disadvantage that it is very restricted in its use, particularly also with regard to the convertible amount of hydrogen-containing exhaust gas, in order to avoid the above-mentioned disadvantages from becoming too large. The use is thus afflicted with decisive disadvantages and, due to the restriction of the hydrogen-containing exhaust gas with regard to amount, in order to minimize the disadvantages, is restricted to the use in a construction with an anode recirculation cycle.

U.S. Patent Application Publication No. US 2005/0019633 A1 further discloses a fuel cell system with an anode recirculation cycle. With this system, the exhaust gas discharged from time to time from the anode cycle is mixed with exhaust gas from the region of the cathode, in general used air, and is combusted in a catalytic combustor. With the catalytic combustion of the dehumidified used air and the exhaust gas from the anode region, a corresponding heat amount results, which can be used to heat the cooling cycle of the fuel cell system.

This operating guidance certainly represents a corresponding advantage for the cold start of such a fuel cell system, for the regular operation it is, however, very critical to supply this exhaust heat to the cooling water, as the cooling surface available, for example, with a use in a vehicle is rather not or only badly sufficient to cool the fuel cell sufficiently. Additionally, the exhaust heat resulting in the region of the catalytic burner is not used actively with the construction of U.S. Patent Application Publication No. US 2005/0019633 A1, apart for the cold start case.

German patent document DE 10 2007 003 144 A1 discloses a fuel system comprising an exchanging device, which combines the two functions “cooling” and “humidification”. The exchanging device, which is referred to as a function unit in that document, permits a material flow from the used air of the fuel cell to the intake air to the fuel cell, while a heat exchange from the intake air heated by a compression device to the comparatively cool exhaust air likewise takes place. German patent document DE 10 2007 003 144 A1 additionally shows a construction, where the air supply of the fuel cell system is realized via a compressor, which can be driven by a turbine and/or an electric motor. This generally known construction with fuel cell systems is also called an electric turbocharger and permits the at least supporting drive of the compressor, and, with a power excess of the electrical machine as a generator, through the turbine.

Exemplary embodiments of the present invention improve a fuel cell system in that a conversion of hydrogen-containing exhaust gases is also enabled, as the generation of additional heat, which can beneficially be used in a fuel cell system, and which avoids the above-mentioned disadvantages.

In the fuel cell system according to the invention, the catalytic material is divided into two different units. The units with the catalytic material can thereby be formed as independent catalytic components. It is, however, also possible to integrate these into other components, tube lines or the like. The division of the catalytic unit in such a manner according to the invention is achieved such that a first unit in the flow direction of the intake air is arranged upstream of at least one first device connected upstream of the fuel cell. Exhaust gas from the anode region is supplied to this first catalytic unit, which can react therein with oxygen from the intake air flow. The resulting heat which could possibly be damaging for the fuel cell itself, is introduced into the intake air flow by means of the arrangement in such a manner that it can be used or broken down in the device. A second catalytic unit is provided in the fuel cell system, which is present in the used air system from the cathode region. This catalytic unit can particularly be used to achieve a corresponding increase of the temperature of the used air flow by means of additional fuel, for example, to use this as thermal energy, or to convert this into another energy form by means of suitable devices.

According to a particularly favorable arrangement of the invention, the at least one device is formed as an exchanging device, in which heat from the intake air transfers to the used air and water vapor from the used air to the intake air. By means of such an exchanging device, as is also known as a functional unit for cooling and humidifying of the above-mentioned state of the art, the fuel cell system is simplified further with regard to the number of its components. As the exchanging device has a comparable function as the charge-air cooler integrated therein, comparable advantages occur with the use of such an exchanging device, as already mentioned above.

According to a further very advantageous and favorable arrangement of the fuel cell system, the intake air is fed via a compressor arranged upstream of the at least one device, wherein the compressor can be driven by a turbine at least in a supporting manner, which is flown through by the used air downstream of the at least one device. This turbine permits use of the energy present in the used air. Typically, present-day fuel cell systems are operated with only a little excess pressure compared to the environment. The primary energy content in the used air, which can be used by the turbine, is thus present in the exhaust heat in the used air flow. Because the exhaust heat in the used air flow can be increased via the second catalytic unit in a defined manner, this exhaust heat can also be used in a defined manner via this turbine. Thus, it is possible to use the energy resulting in the system in an ideal manner through the turbine, and for example to, with an abrupt power requirement at the compressor, provide this via a catalytic conversion of additional fuel in the region of the second catalytic unit.

In a further very favorable arrangement of this version of the invention, the compressor can be driven by an electrical machine, wherein, with a power excess at the turbine, the turbine drives the electrical machine in a generator manner for generating electrical power. The needed heat energy provided via the second catalytic unit can thus not only be used via the turbine in order to drive the compressor, but can also drive an electrical machine as a generator in a targeted manner. The generated heat energy can be converted to electrical energy, which can satisfy an electrical power requirement. If, for example, an abrupt increase of the required power results, the electrical power generated from the hot used air via the turbine and the electrical machine can bridge the comparatively inert response of the fuel cell to such a power requirement.

The fuel cell system according to the invention in all its shown versions thus permits a simple, compact and thus also cost-efficient construction with an ideal arrangement for the life span and the efficiency that can be achieved. The fuel cell system according to the invention is thus particularly suitable for the use in a means of transport, and here for the generation of power for the drive and/or electrical auxiliary users in the means of transport. A means of transport is any type of means of transport on land, on water or in the air, wherein a particular attention is certainly in the use of these fuel cell systems for motor vehicle with no rails, without the use of a fuel cell system according to the invention being restricted hereby.

Further advantageous arrangements of the fuel cell system according to the invention will become clear by means of the exemplary embodiments, which are described in more detail in the following with reference to the figures.

### BRIEF DESCRIPTION OF THE DRAWING FIGURES

It shows thereby:

FIG. 1 an embodiment of the fuel cell system according to the invention;

FIG. 2 a further embodiment of the fuel cell system according to the invention;

FIG. 3 an alternative embodiment of the fuel cell system according to the invention; and

FIG. 4 a further alternative embodiment of the fuel cell system according to the invention.

### DETAILED DESCRIPTION

The depiction in the following figures only shows the components necessary for the understanding of the invention of the rather complex fuel cell system per se present here in a highly schematized depiction. It should thereby be understood for the fuel cell system that further components, as for example a cooling cycle and the like are also provided in the fuel cell system, even though these are not considered in the figures shown in the following.

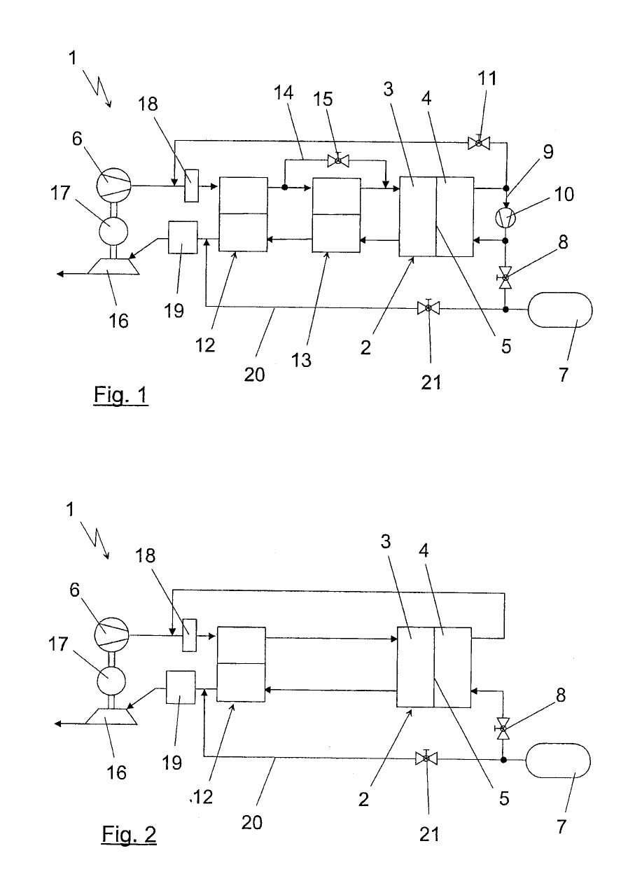

FIG. 1 illustrates a fuel cell system 1 comprising a fuel cell 2. The fuel cell 2 includes a stack of individual cells constructed in a customary manner. A cathode region 3 and an anode region 4 is formed in the fuel cell, which regions are separated from each other by a membrane 5 of a polymer electrolyte (PE) in the present example of a PEM fuel cell 2. In the embodiment shown in FIG. 1, an intake air flow is supplied to the cathode region 3 via a compressor 6. The compressor 6 can thereby, for example, be designed as a screw compressor or as a flow compressor, as is customary with fuel cell systems. Basically, other possibilities for compressing the supplied air flow are, however, also conceivable, for example by a piston machine or the like. The intake air flow fed to the cathode region 3 reacts to water with the hydrogen fed to the anode region 4 in the fuel cell 2, whereby electrical power is released. This principle of the fuel cell 2 known per se only has a subordinate role for the present invention, this is why it shall not be explained in more detail.

Hydrogen from a hydrogen storage device 7, for example, a pressurized storage device 7, is guided into the anode region 4. It would also be possible to supply the fuel cell 2 with a hydrogen-containing gas, which is, for example, generated from hydrocarbon-containing starting materials in the region of the fuel cell system. In the exemplary embodiment of FIG. 1, the hydrogen from the hydrogen storage device 7 is guided into the anode region 4 via a dosing device 8, only shown schematically here. The exhaust gas flowing from the anode region 4, which gas generally still contains a comparatively high amount of hydrogen, is fed back into the anode region 4 via a recirculation line 9 and a recirculation feed device 10. In the region of this recirculation, fresh hydrogen discharged from the hydrogen storage device 7 is supplied, so that a sufficient amount of hydrogen is always available in the anode region 4. The construction of the anode region 4 of the fuel cell 2 with the recirculation line 9 and the recirculation feed device 10 is thereby known per se and customary. A gas jet pump can, for example, be used as recirculation feed device 10, which pump is driven by the fresh hydrogen discharged from the hydrogen storage device 7. Alternatively, a recirculation blower is also possible as recirculation feed device 10. Combinations of these different feed device are naturally also possible, which shall also be included in the definition of the recirculation feed device 10 according to the present invention. It is additionally known with the use of a recirculation of anode exhaust gas, that inert gases, as for example nitrogen, accumulate over time in the region of the recirculation line 9, which gases reach the anode region 4 from the cathode region 3 through the PE membrane 5. In order to be able to further provide a sufficient concentration of hydrogen in the anode region 4, it is thus necessary to discharge the exhaust gas of the anode region in the recirculation line from time to time. For this, a discharge valve 11 is provided in the exemplary embodiment according to FIG. 1, through which valve the exhaust gas from the anode region 4 can be discharged from time to time. This process is often also called “purge”. The exhaust gas thereby always also contains a corresponding amount of residual hydrogen in addition to the inert gases.

The intake air flowing from the compressor 6 to the cathode region 3 flows through an exchanging device 12 as a first unit in the construction of the fuel cell system 1 according to FIG. 1, which exchanging device serves to correspondingly cool the hot intake air from the compressor 6. For this, the cool used air from the cathode region 3 of the fuel cell 2 flows through the heat exchanging device 12 on the exhaust air side. The heat exchanging device 12 is usually also called charge-air cooler. After the intake air flows through the heat exchanging device 12, it reaches a humidifier 13, in which the dry and now cooled intake air is humidified by the humid used air of the cathode region 3, which entrains the largest part of the product water resulting in the fuel cell 2 as water vapor. For this, the humidifier 13 is equipped with membranes permeable by water vapor in a conventional design, which are flown through on the one side by the dry intake air and on the other side by the humid used air. FIG. 1 also shows a bypass line 14 with a valve device 15, through which the humidifier 13 can be bypassed from the intake air to the cathode region 3.

In the fuel cell system 1 of FIG. 1, a turbine 16 and an electrical machine 17 can also be seen. The electrical machine 17 can drive the compressor 6 as a motor. It can, for example, be arranged on a shaft with the compressor, or could also be coupled indirectly to the compressor 6 via a corresponding transmission. Compared to this, the electrical machine 17 and the compressor 6 are coupled directly or indirectly to the turbine 16. The used air thereby discharges thermal energy and pressurized air in the turbine 16. The power thus provided by the turbine 16 can be used to drive the compressor 6 at least in a supporting manner. With a corresponding power excess at the turbine 16, the electrical machine 17 can also be operated as a generator. A corresponding current can then be provided via the electrical machine, which can be used for other uses in the fuel cell system 1 or also in an electrical system supplied by the fuel cell system 1, as for example the drive system of a vehicle.

The construction of the fuel cell system described up to now corresponds to a fuel cell system known from the state of the art, which operates in a comparable function as fuel cell systems 1 from the state of the art constructed in an analogous manner.

The decisive difference of the fuel cell system 1 compared to the state of the art now involves two units 18, 19 being provided in the fuel cell system 1, which respectively comprise a catalytic material for the thermal conversion of a fuel-containing gas. The units 18, 19 are thus also called catalytic units 18, 19 in the following. The first catalytic unit 18 is arranged in the intake air flow to the cathode region 3 of the fuel cell 2. The exhaust gas discharged from the anode region 4, in the exemplary embodiment shown here the exhaust gas from the anode cycle, is now supplied to the first catalytic unit 18 or to the intake air in the flow direction upstream of the first catalytic unit 18 from time to time. In the region of the first catalytic unit 18, the hydrogen contained in this exhaust gas reacts with oxygen from the intake air fed from the compressor 6. This results in heat and water in the form of water vapor. The additional heating of the intake air flow is comparatively uncritical at the location where the catalytic unit 18 is arranged, as the intake air is cooled in any case by the exhaust air via the heat exchanger 12 in the flow direction downstream of the first catalytic unit 18. The water vapor resulting with the catalytic conversion in the region of the first catalytic unit 18 is an advantage at this location, as it humidifies the hot and dry intake air from the compressor. Due to the very low amount of residual hydrogen with an operation with an anode cycle, this humidification will certainly not be sufficient, but it can support the humidification occurring in the humidifier 13 in an advantageous manner.

The second catalytic unit 19 is arranged in the used air flow from the cathode region 3 of the fuel cell 2, namely in the flow direction of the used air downstream of the heat exchanger 12. Hydrogen as fuel can now also be supplied to this second catalytic unit 19 or to the used air in a region upstream of the second catalytic unit 19 via a guide element 20 and a valve device 21. Instead of hydrogen, another fuel could also be used, if it would be available in the fuel cell system, for example a hydrocarbon-containing fuel, if a hydrogen-containing gas is generated for the fuel cell system from such a starting material by means of a gas generating device.

By means of the additionally supplied fuel or hydrogen, the used air, which already has a comparatively high temperature after flowing through the heat exchanger 12, can again be further heated by the catalytic unit 19. This can, for example, be used to avoid the discharge of liquid product water from the fuel cell system 1 and to evaporate all water present in the used air. The additional heating of the used air by the catalytic unit 19 can, however, be used to supply the turbine 16 with additional power. As the pressure level in present-day fuel cell systems is only a few bar above the surrounding pressure, the used of the exhaust heat when generating power through the turbine 16 plays the bigger part. If additional heat is now introduced into the used air flow via the catalytic unit 19, it can contribute to the power output of the turbine 16 in a decisive manner. Particularly, an increased drive of the compressor 6 can take place in certain operating situations via the turbine 16, for example, if a high electrical power requirement is abruptly directed to the fuel cell 2 and this correspondingly requires a high amount of intake air, while the used air driving the turbine 16 is still present with a comparatively low volume flow. The increased power requirement can then be provided via the turbine by means of the additional introduction of thermal energy via the catalytic unit 19. It is also conceivable to provide so much power by the turbine 16 in these situations that it can provide additional electrical power via the electrical machine 17, which then operates as a generator. Such a boost operation can, for example, be used to support or bridge the rather inert electrical response of the fuel cell 2. With the use of the fuel cell system in a means of transport, this additionally provided power could, for example, be used for supporting a fast acceleration via an electric drive.

The constructions of the fuel cell systems in the following figures are similar to the construction of the fuel cell system 1 in FIG. 1. Thus, the same reference numerals are used in the description of the following figures and only the differences and further development according to the invention with regard to the previous figures is discussed in more detail.

In contrast to the fuel cell system 1 in FIG. 1, the construction of the fuel cell system 1 in FIG. 2 does not have a humidifier 13, and thus also no bypass line around this humidifier. Additionally, the anode region 4 of the fuel cell in the fuel cell system 1 of FIG. 2 is not operated with an anode cycle, but is continuously flown through by hydrogen from the hydrogen storage device 7. In order to ensure a conversion of the hydrogen flowing in the anode region 4 that is as good as possible, the anode region can thereby constructed in a cascading manner. This construction known from the state of the art is thereby designed in such a manner that the anode region 4 is divided into different active partial regions, wherein the partial regions succeeding each other in the flow direction of the hydrogen respectively have a smaller active surface than the partial regions lying upstream thereof in the flow direction. Accordingly, the provided active surface of the partial regions respectively adapts to the remaining volume flow of the hydrogen despite reacting hydrogen, and thus no unnecessary surface has to be provided. With such a construction of the anode region 4 of the fuel cell 2 it is possible to operate this with a very low excess of hydrogen of about 3-5%. This residual hydrogen then flows as exhaust gas from the anode region 4 just as continuously as the fresh hydrogen flows to the anode region 4. In the fuel cell system of FIG. 2, this exhaust gas now passes analogously to the exhaust gas from the anode loop of FIG. 1 into the intake air, namely in the flow direction upstream of the first catalytic unit 18. The exhaust gas or the residual hydrogen of which the exhaust gas largely consists, can then react with oxygen from the intake air flow in the region of the first catalytic unit 18. This, as already mentioned above, will result heat and water in the form of water vapor. The heat is again cooled via the heat exchanger 12, the water vapor reaches the cathode region 3 of the fuel cell 2 and humidifies the PE membranes 5 there. As a continuous hydrogen flow to the region of the first catalytic unit 18 takes place in the fuel cell system 1 of FIG. 2, hydrogen also continuously results therein. An additional humidification of the intake air flow can thus be foregone with a suitable design of the system.

The first catalytic unit 18 can thereby be formed as an independent component as is shown in FIG. 2, but it would also be possible to form the second catalytic unit as a region of the heat exchanger 12, particularly the region on the inlet side in the flow direction of the intake air. This would have the additional advantage that the heat resulting in the catalytic unit 18 would not only be transferred to the used air flow via the intake air flow by the heat exchanger 12, but that, with a corresponding arrangement of the catalytic material in the heat exchanger 12, for example, a coating or a partial coating of the heat exchanger plates, if the heat exchanger 12 is formed as a plate heat exchanger, resulting heat can also be transferred directly to the used air flow, so that the available exhaust heat can be enlarged in the used air flow and the temperature of the intake air flow can be reduced simultaneously.

The construction of the fuel cell system of FIG. 1 on the used air side is thereby identical to the construction as has already been described in FIG. 1.

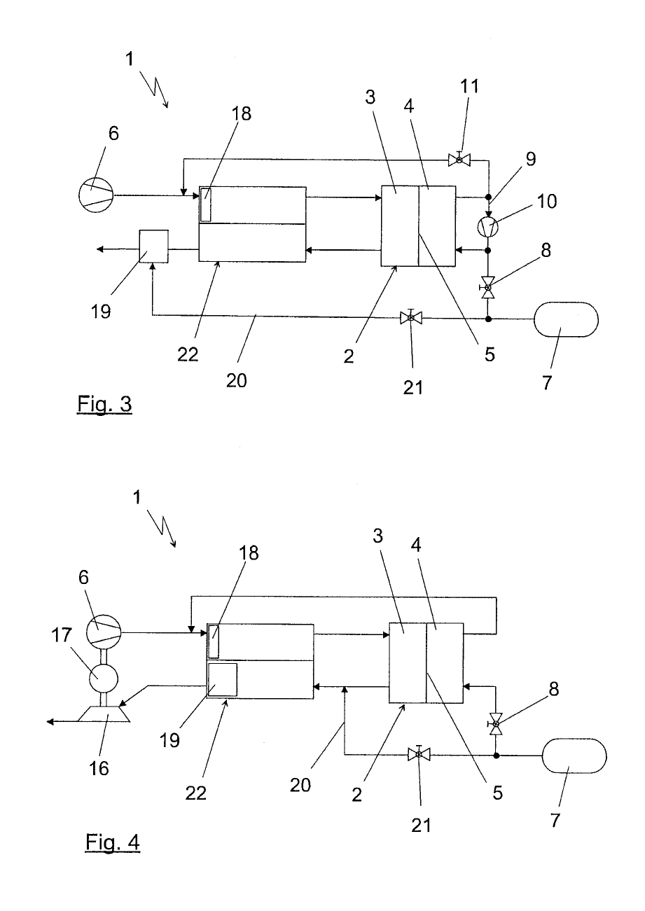

The fuel cell system 1 of FIG. 3 now again has an anode recirculation line 9 and a recirculation feed device 10. The exhaust gas from the anode region 4 is discharged again in this exemplary embodiment via the valve device 11 from time to time. Otherwise, the turbine 16 and the depiction of the electrical machine 17 is foregone in the fuel cell system 1 of FIG. 3, as these are also not necessary for the fuel cell system 1 according to the invention. The heat exchanger 12 and the humidifier 13 are thereby combined to a single functional unit in the fuel cell system 1 of FIG. 3, a unit called exchanging unit 22 in the following. This exchanging unit 22 ensures the material exchange of the water vapor from the used air to the intake air, and also the material transfer from the intake air heated by the compressor 6 to the used air. Such an exchanging device is known in principle from the state of the art, for this, we refer to German patent document DE 10 2007 003 114 A1 already mentioned above.

In the fuel cell system 1 of FIG. 3, the first catalytic unit 18 is additionally integrated into the exchanging device 22. This can, for example, take place by a coating, particularly of a partial region, of the intake air side of the exchanging device 22, approximately analogous as can also be carried out with the integration into the heat exchanger, which has already been described above. In a particularly favorable arrangement, the exchanging device 22, is operated in a counterflow or at least to a large part in a counterflow. This has the advantage that the humid and cold used air in the exchanging device 22 first comes into contact with the intake air that is already cooled comparatively to a high extent and slightly humidified. With the through-flow of the exchanging device 22, the used air then increasingly comes into contact with drier and hotter intake air, so that it can absorb heat and discharge water vapor to the intake air. Only just before the used air leaves the exchanging device 22, it also comes into contact with the exhaust heat generated by the catalytic material in the first catalytic unit 18 and absorbs this exhaust heat present at a relatively high temperature, before it leaves the exchanging device 22. The region with the catalytic material, thus the region of the integrated first catalytic unit 18, can thereby be formed comparatively small, for example about 1/16 to ⅛ of the area of the exchanging device 22 available, as less hydrogen occurs here.

In a particularly advantageous arrangement, the exchanging device 22 can consist of a honeycomb material, for example a ceramic honeycomb body, as is used for exhaust gas catalysts. This honeycomb body can be formed in such a manner that the intake air and the used air in a counterflow flows through the individual adjacent channels. By means of a corresponding coating, it can be ensured that water vapor can reach the intake air side from the used air side at least in partial regions, and that a heat exchange between the materials takes place at least in possibly another partial region. The intake air side can additionally be provided with a corresponding catalytic coating, for example, also only in one partial region. The supply of the exhaust gas from the anode region 4 can thereby take place as already described directly into the intake air downstream of the compressor 6. It would, however, also be conceivable to introduce the exhaust gas directly into the exchanging device and here particularly into the region of the first catalytic unit 18.

On the used air side, the fuel cell system according to FIG. 3 is only distinguished slightly from the previously described exemplary embodiments. The fuel cell system thus does not have a turbine here, so that thermal energy generated in the second catalytic unit 19 can only be used for evaporating the product water in the used air, or for the use as thermal energy for example for heating a vehicle interior, a cooling cycle or the like.

The construction of the fuel cell system 1 in FIG. 4 now again comprises the unit of compressor 6, electrical machine 17 and turbine, it would again be suitable for a use with a boost operation, as has already been described within the scope of the depiction of FIG. 1. Otherwise, the fuel cell system 1 in the arrangement according to FIG. 4 again shows the exchanging device 22 instead of a heat exchanger and/or a humidifier. However, in analogy to FIG. 2, the anode region 4 is not provided with a recirculation line 9. Thereby, a continuous exhaust gas flow from the anode region 4 is also present with the fuel cell system 1 in the arrangement according to FIG. 4. This is again supplied to the first catalytic unit 18 analogously to the arrangement of FIG. 2, which is again formed integrated into the exchanging device 22 here.

The actual difference of the fuel cell system 1 in the arrangement according to FIG. 4 is on the used air side. The second catalytic unit 19 is thereby also integrated into the exchanging device 22. It is in the flow direction of the used air in the region in which used air flows from the exchanging device 22. This has the advantage that a high heating of the used air takes place by the catalytic unit 19, which can then, for example, be used in the turbine 16, as shown in FIG. 4. The exhaust heat resulting in the region of the catalytic unit 19 can thereby primarily be used for heating the used air in the outflow region of the used air side with this arrangement. The heat transfer into the region of the intake air side can thus be kept as low as possible. This can additionally be supported by providing suitable means in the region of the catalytic unit 19 in the exchanging device 22, in order to prevent or at least impede the heat transfer in the region of the intake air. These means can, for example, be an arrangement with materials that do not conduct heat well or possibly an air gap between the two sides in the region of the catalytic unit 19. The heat generated by the catalytic unit 18, which is also present and integrated into the exchanging device 22, would have to be transferred again via the intake air to the used air, as such an arrangement would also impede the direct contact and the direct transfer of the heat to the used air. As the catalytic unit 19 is, however, typically designed clearly larger than the catalytic unit 18, and thus a comparable large amount of heat is generated from the supplied fuel and the oxygen present in the used air compared to the conversion of the exhaust gas from the anode region, it is acceptable.

The construction of FIG. 4 thus allows to use the exhaust gas from the anode region 4 with a single construction unit, namely the exchanging device 22 with the two integrated catalytic units 18, 19 without straining the fuel cell 2 itself in an unnecessary manner or to accelerate its ageing and additionally to condition the intake air to the fuel cell 2 in an ideal manner. Further, the heat transferred to the used air via the second catalytic unit 19 and from the hot intake air can be realized via the second catalytic unit 19, which permits the operation of the turbine 16, for example for driving the compressor and/or to drive a generator. The supply of the hydrogen as additional fuel takes place in the exemplary embodiment shown here into the used air downstream of the cathode region 3 of the fuel cell 2. It would, however, also be possible to introduce this fuel directly into the region of the second catalytic unit 19. As the exchanging device 22 will, however, typically be constructed in a very complex manner, the supply of the content materials into the gas inlets, in which this can, for example, take place by means of a T piece or by the connection of two lines, is generally preferred due to reasons of complexity and costs.

The embodiment variants of the construction according to the invention shown here can be combined among each other in an arbitrary manner, for example only one or none of the catalytic devices could be integrated into a heat exchanger or an exchanging device. The fuel cell system could also be operated with or without a turbine and with or without a humidifier, as with or without the cycle guidance of the hydrogen around the anode region. It would additionally also be possible that a bypass line 14 with a corresponding valve device 15 is arranged around the exchanging device 22 at the air intake side or the used air side, in order to be able to control the humidification here when needed.

1-16. (canceled)

17. A fuel cell system comprising:
at least one fuel cell that has a cathode region and an anode region;
at least one device, which is arranged such that an intake air flow flowing to the cathode region and a used air flow discharged from the cathode region flows through the at least one device;
a first unit with catalytic material is arranged upstream of the at least one device in a flow direction of the intake air flow wherein an exhaust gas from the anode region is fed to the first unit as a fuel-containing gas; and
a second unit with catalytic material is arranged downstream of the at least one device in a flow direction of the used air flow,
wherein the catalytic material of the first and second units thermally converts fuel-containing gas.

18. The fuel cell system according to claim 17, wherein the at least one device is a heat exchanger, in which heat transfers from the intake air to the used air.

19. The fuel cell system according to claim 17, wherein the at least one device comprises a first and second device, wherein the first device is a heat exchanger in the flow direction of the intake air, in which heat transfers from the intake air to the used air, and the second device is a last device in the flow direction of the intake air upstream of the cathode region is a humidifier, in which water vapor from the used air transfers to the intake air.

20. The fuel cell system according to claim 16, wherein the at least one device is an exchanging device, in which heat transfers from the intake air to the used air and water vapor transfers from the used air to the intake air.

21. The fuel cell system according to claim 19, wherein a bypass line with a controllably closeable flow cross-section is arranged around the humidifier.

22. The fuel cell system according to claim 20, wherein a bypass line with a controllably closeable flow cross-section is arranged around the exchanging device.

23. The fuel cell system according to claim 19, wherein the first unit with the catalytic material is integrated into the first of the at least one device on an intake air side in the flow direction of the intake air.

24. The fuel cell system according to claim 19, wherein the second unit with the catalytic material is integrated into the second of the at least one device on an used air side in the flow direction of the used air.

25. The fuel cell system according to claim 24, wherein means are provided in a region of the catalytic material of the second unit with catalytic material, by which the thermal transfer from the used air side to the intake air side is impeded.

26. The fuel cell system according to claim 17, wherein hydrogen is supplied to the second unit with the catalytic material.

27. The fuel cell system according to claim 17, wherein the catalytic material of the first and second units is a coating or the at least one device includes the catalytic material.

28. The fuel cell system according to claim 17, wherein the at least one device has at least partially a honeycomb structure.

29. The fuel cell system according to claim 20, wherein the exchanging device is flown through essentially in a counterflow, wherein the catalytic material is arranged on an intake air side in a region where the intake air and the exhaust gas flow into the exchanging device and in which the used air flows from the exchanging device.

30. The fuel cell system according to claim 29, wherein the catalytic material of the second unit is arranged at a used air side in a region, in which the used air flows out from the exchanging device and in which the intake air and the exhaust gas flow into the exchanging device.

31. The fuel cell system according to claim 17, wherein the intake air is fed via a compressor arranged upstream of the at least one device, wherein the compressor is driveable a turbine, at least in a supporting manner, which is flown through by the exhaust air downstream of the last at least one device.

32. The fuel cell system according to claim 31, wherein the compressor is driveable by an electrical machine, wherein the turbine drives the electrical machine in a generator manner to generate electrical power with a power excess at the turbine.

33. A method of using a fuel cell system comprising at least one fuel cell having a cathode region and an anode region, the method comprising:
passing an intake air flow flowing to the cathode region through at least one device;
passing a used air flow discharged from the cathode region flows the at least one device;
feeding an exhaust gas from the anode region to a first unit with catalytic material as a fuel-containing gas, wherein the first unit with catalytic material is arranged upstream of the at least one device in a flow direction of the intake air flow;
wherein a second unit with catalytic material is arranged downstream of the at least one device in a flow direction of the used air flow, and
wherein the catalytic material of the first and second units thermally converts fuel-containing gas.
